(19) United States
(12) Patent Application Publication
(10) Pub. No.: US 2002/0197097 A1
(43) Pub. Date: Dec. 26, 2002

(54) WASHCLOTH THAT MAKES BUBBLES

(76) Inventor: Shahrokh Rabbani, Tarzana, CA (US)

Correspondence Address: ALBERT O COTA, 5460 WHITE OAK AVE, SUITE A-331, ENCINO, CA, 91316, US

(21) Appl. No.: 09/891,862

(22) Filed: Jun. 25, 2001

(51) Int. Cl. A47K 7/03; A46B 5/02; B43K 8/10

(52) U.S. Cl. 401/201; 15/222; 401/6

(57) ABSTRACT

A hand-held device is a balloon like fabric or alike, for washing and scrubbing a body part therewith and for capturing a washing article, such as, but not limited to, a bar of soap or other washing and cleaning agents, or even all therein. The device is blown in by mouth, and tied up at the neck by attached closing article, such as, but not limited to, a string or other clipping devices, or even both. The device includes a balloon like body, that could have any shape, and includes a neck for holding and inserting the cleaning article and blowing air into the body. There after by pushing on the body of the device, bobbles would come out of it. The body also includes a pair of handles for holding and washing the body parts, and can be used for hanging the device.

### BACKGROUND OF THE INVENTION

1. Field of the Invention

The present invention relates to a hand-held device for washing and scrubbing the body, which generates bobbles. More particularly, the present invention relates to a hand-held device which by capturing a washing article within and blowing into it, it generates bubbles for washing the body parts, and enjoying the bobbles while showering or bathing.

2.Description of the Prior Art

Various devices and washcloth types for body washing and engaging a bar of soap and other type of detergents therein have been invented. Even though these inventions may be suitable for specific individual to which they address, however they differ, and function differently from the present invention. This invention using a washing article as well, generates bobbles while taking a shower of a bath. The difficulty with some of them is reaching the back of a person with ease, another is that they usually being used for scrubbing with a bar of soap and the result is like the conventional washcloth with a soap in it that might slip out and does not cerate necessary bobbles for soaping and joy. Additionally, conventional bathing with bobbles, one should take a bath that results in wasting a lot of water, time and energy. One more problem that some of this inventions do not solve is that when the soap gets small and hard to handle, they dispose of it, which creates another problems like waste of our recourses and not fully getting the result of cleaning that one is after, not mentioning the hazards of slipping on a bar of soap. This inventions solves all this problems and adds the joy to taking a shower with bobbles, or a bath with easier, faster and more economical method.

### SUMMARY OF THE INVENTION

A object of the present invention, is to provide a hand-held device for washing and scrubbing the body parts therewith, and capturing a washing article therein that creates bobbles and adds the ease of washing and joys of taking a bubble-shower or bath.

Another object of the present invention is to provide a hand-held device for washing and scrubbing the body parts therewith and for capturing a washing article that is simple to manufacture and use.

Still another object of the present invention is to provide a hand-held device for washing and scrubbing the body parts therewith and for capturing a washing article that time saving when used, and prevents waste or our recourses, such as water and the washing articles and it is safe to use.

Furthermore another object of the present invention is to provide a hand-held device for washing and scrubbing the body parts therewith and for capturing a washing article, such as, but not limited to soap, or other washing and bubbling agents or both. The device includes a balloon like body with a void inside, with an opening on one side for inserting and removing the washing article therein and therefore, and blowing air into the body to inflate it, while holding it by the neck. This body have a fabric like body member, that is flexible, and material such as, but not limited to cotton, nylon, or verity of cloths Or combination of them, that forms it's shape by stitching around it. This body will be impregnated by moving or robbing it to the washing article inside, with the particles of the washing article, so that it will generate bobbles to the outside of the body after it's been blown into and pushed on or squeezed.

To the body is attached a cord that will be used to close the neck after inflation, to keep the air inside. At the two end of the body are attached handles for holding the device by two hand and washing the hard to reach body-parts and, further more for hanging the device after use. These handles will be made of straps or cords and alike material so they would not scratch the body-parts, and be convenient to use. It is, another purpose of these handles to make it easy for people with disabilities to reach all parts of their body-parts with ease.

### BRIEF DESCRIPTION OF THE DRAWINGS

The figures on the drawing are briefly described as follows:

FIG. 1 is a diagrammatic perspective view of the present invention in use in a shower or in the bathtub;

FIG. 2 is a diagrammatic perspective view of the present invention from side and above;

FIG. 3. is a diagrammatic perspective view of the present invention in use and in state of being blown into, for use on FIG. 1;

FIG. 4 is diagrammatic perspective view of present invention after being blown into and closed at the neck, ready for use.

List of Reference Numerals Utilized in the Drawings:

10 Hand-device of present invention for washing and scrubbing body parts 21 therewith and capturing washing article 17 and/for generating bobbles.

11 Body of present invention.

12 Neck of present invention for inserting the washing article 17, and for holding the device for blowing into the body 11 and closing it with string 16.

13 Grabbing handle.

14 Grabbing handle.

15 The opening for inserting the washing article and blowing air into the body 1.

16 The string for tying the neck 12 after the body 11 has been inflated.

17 Washing article.

18 Bobbles.

### DETAILED DISCRIPTION OF INVENTION

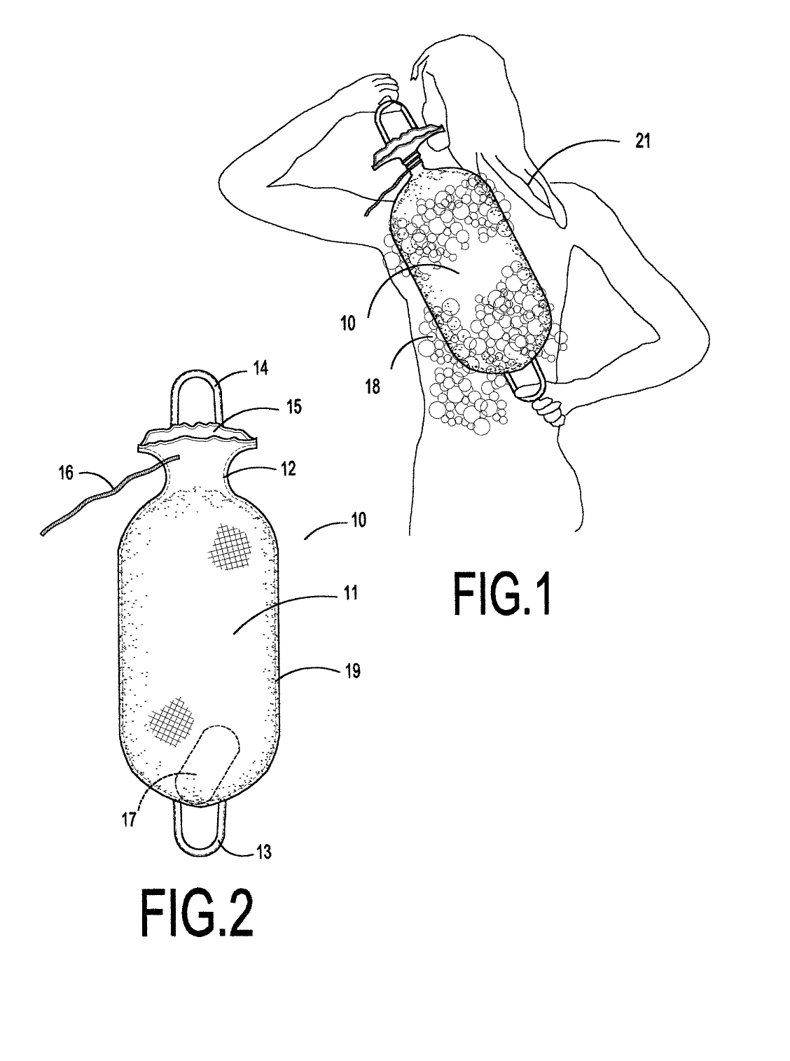

Referring now to the figures, in which numerals indicates parts, particularly in FIG. 1 the present invention 10 is shown in use for washing and scrubbing body parts with bobbles.

The present invention as shown in FIG. 2 is compromises of two identical pieces of predetermined dimension cloths sewn together at stitch line 19, with an opening 15 at one side, creating a cavity in between them Furthermore a piece of string 16 also attached to the neck 12, in the same manner, for closing it after the body has been inflated.

Yet furthermore two handles 13 and 14, preferably made of same cloth, but not necessarily, have been attached to the two ends, lengthwise, for grabbing and washing or scrubbing body parts, specially the hard to reach body parts like the back. One of the handles can be used for hanging the device from a hook or alike.

Device 10, being wetted and having washing article 17 or other washing and bobbling agents inserted inside from the opening 15 and through the nock 12, by moving and rubbing the washing article 17 inside of the body 11, absorbs the soap particles to the cloth of body 11 and impregnates it with this articles.

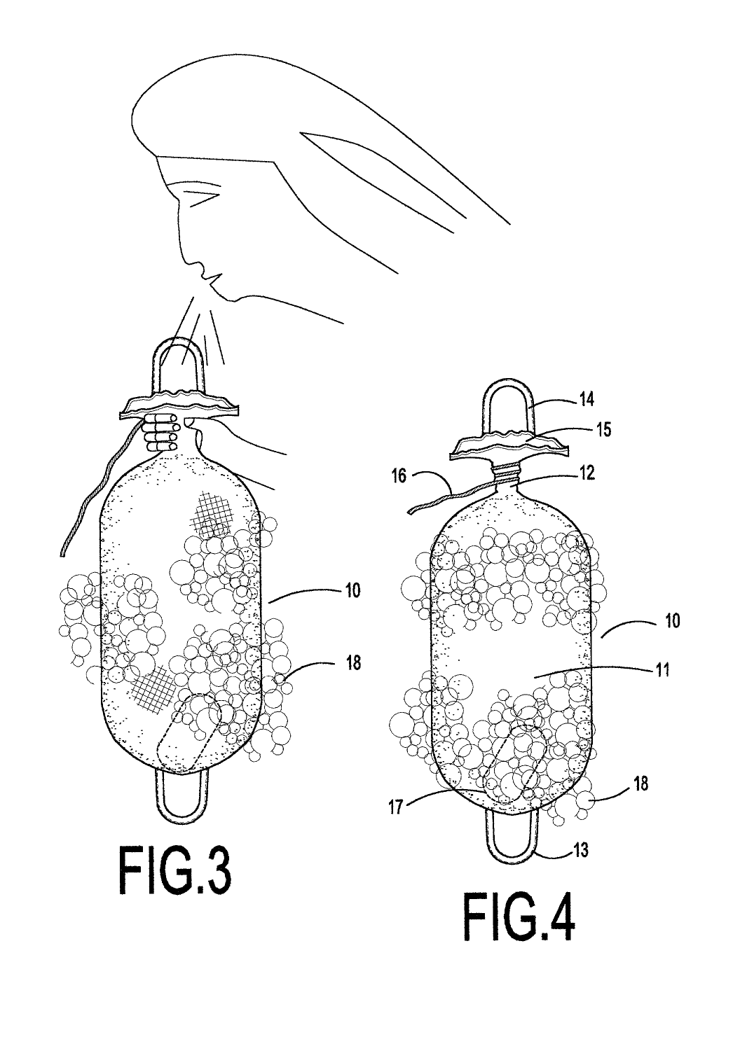

When the body is soaped and ready, by holding the present invention by the neck 12 and blowing into it though the opening 15 and the neck 12,as shown in FIG. 3, the body 11 will be easily inflated till it would get its balloon like shape. By holding the neck 12, tying and warping the string 16 around it, the air will be trapped inside of body 11 and bobbles would start coming out of outer surface of the body 11, as shown in FIG. 4. Then having this device on one's body parts 21, or other body parts, by pushing gently on the body 11, bobbles 18 will come out of the body 11 so they can be rubbed to other body parts, and at the same time and after the body 11 has been deflated, by grabbing the two handles 13 and 14 one can wash and scrub his or her body parts.

If needed the device can be inflated again and again as desired.

I claim:

1. A hand-held device for washing and scrubbing the body part therewith and for capturing a washing article therein, that by being wetted and blown into, then by closing it at the neck and by pushing on the said device, it generates bobbles, for washing the body parts and enjoying the bobbles while showering or bathing, therefore it comprises a body being hollow for capturing the washing article and air, and having a neck and an opening for holding it and inserting the washing article to the body of the device, and blowing air into the body of the device which have two kind of surfaces, a smooth side like cotton and a rough side like terry cloth, future more the device has a string attached to the neck for closing the neck after the air has been blown into the body, and contains it within, and having a pair of handles for grabbing by the hands of a user for reaching and washing the body parts, and hanging the device after use.

2. The device as defined in claim 1, wherein said body is balloon like, that could have any shape and geometry.

3. The device as defined in claim 1, wherein said washing article is a bar of soap.

4. The device as defined in claim 1, wherein said washing article is washing and bobbling agent.

5. The device as defined in claim 1, wherein said the body comprises synthetic fibers.

6. The device as defined in claim 1, wherein said the body comprises natural fibers.

7. The device as defined in claim 1, wherein said the body comprises a blend of natural and syntactic fibers.

8. The device as defined in claim 1, wherein said wash cloth comprises cotton fibers.

9. The device as defined in claim 1, wherein said wash cloth comprises terry cloth.

10. The device as defined in claim 1, wherein the string can be replaced with a clipping or other closing devices.
